(19) United States
(12) Patent Application Publication
(10) Pub. No.: US 2006/0197267 A1
(43) Pub. Date: Sep. 7, 2006

(54) Suspension system for motor vehicles

(75) Inventor: Hubert Beck, Eitorf (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/368,245

(22) Filed: Mar. 2, 2006

(30) Foreign Application Priority Data
Mar. 5, 2005 (DE) 10 2005 010 239.5

(51) Int. Cl. B60G 17/00

(52) U.S. Cl. 267/64.16; 188/318

(57) ABSTRACT

Suspension system for motor vehicles with level control for adjusting the body of the vehicle to a predetermined height, having at least one piston-cylinder unit provided with a working cylinder, a piston rod, and a damping piston with damping valves. A flow connection connects the piston-cylinder unit to an oil reservoir, and a pump in the flow connection conveys damping medium from the piston-cylinder unit to the reservoir. A stop valve, connected in parallel to the pump in the flow connection, controls the return flow of damping medium from the reservoir to the piston-cylinder unit.

### BACKGROUND OF THE INVENTION

1. Field of the Invention

A suspension system for a motor vehicle with level control for adjusting the vehicle body to a predetermined height includes a working cylinder having a working space filled with damping oil, a piston in the working space, damping valves in the piston, a piston rod connected to said piston, and a flow connection connecting the working space to a reservoir containing damping oil.

2. Description of the Related Art

Suspension systems for motor vehicles with level control for adjusting the vehicle body to a predetermined height are already known. See, e.g., U.S. Pat. No. 6,553,761. These have at least one piston-cylinder unit provided with a working cylinder, a piston rod, and a damping piston with damping valves; a pump for an oil reservoir; and appropriate feed and discharge lines from the oil reservoir to the piston-cylinder unit and vice versa. The pump consists of a pump piston and a drive. This level control function of the suspension system works in such a way that, when the vehicle is fully loaded, the pump conveys oil from a low-pressure tank to the high-pressure side of the system to bring the body of the motor vehicle up to the desired level. This process takes a certain amount of time and depends on the power and thus on the physical size of the pump.

### SUMMARY OF THE INVENTION

The object of the invention is to create a suspension system for motor vehicles which is able to bring the body of a loaded vehicle to the desired level in the shortest possible time with a relatively small amount of power, i.e., within a relatively small amount of space, in order that the loaded vehicle can be driven away as quickly as possible.

To accomplish this task, it is provided that the pump in the flow connection conveys damping medium from the piston-cylinder unit to the reservoir, whereas a stop valve, which is connected in parallel to the pump in the flow connection, controls the return flow of damping medium from the reservoir to the piston-cylinder unit.

The advantage of this embodiment is that, during normal driving, a reservoir can be filled with high pressure, so that, when needed, the reservoir will allow the level of the vehicle body to be adjusted quickly.

According to another embodiment, the pump is installed in the flow connection, and the stop valve is installed in an additional flow connection which is parallel to the first flow connection. It is advantageous in this case for the pump and/or the stop valve to be controlled by a sensor, operating in conjunction with an appropriate electronic circuit.

According to another favorable embodiment, the sensor detects the distance traveled by the damping piston. It is advantageous in this case for the sensor, designed as a piston travel sensor, to be installed inside the hollow piston rod.

According to another favorable embodiment, the reservoir is designed as a separate component.

Additional embodiments are possible in which the piston-cylinder unit and the reservoir are both installed in the same component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIGS. 1 and 2 show cross-sectional views of the functional principle; and

FIGS. 3 and 4 show design embodiments of a suspension system with a pump and a stop valve.

### DETAILED DESCRIPTION OF THE PRESENTLY PREFERRED EMBODIMENTS

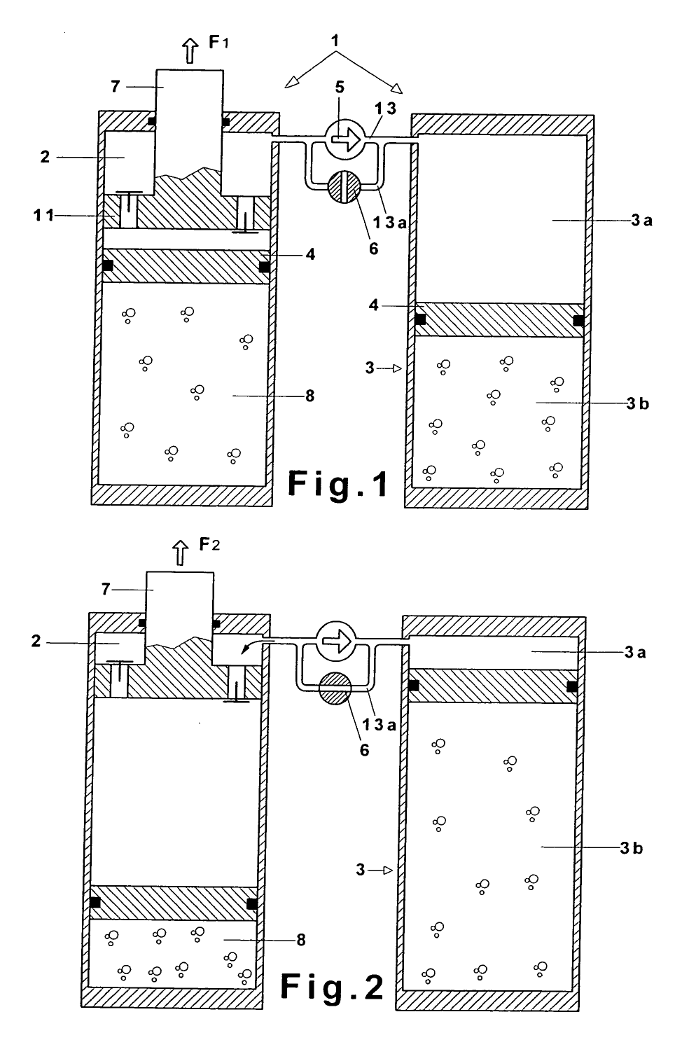

FIG. 1 shows a schematic diagram of a piston-cylinder unit 1, in which a damping piston 11 in the working space 2 is mounted on a piston rod 7, which has freedom of axial movement. The working space 2 is separated from the gas spring space 8 by a separating element 4. An appropriate gas volume is provided in the gas spring space 8.

Via the flow connections 13 and 13a, the working space 2 is connected to a high-pressure reservoir 3. Damping medium is present in the upper space 3a, whereas a gas volume is present in the lower space 3b, separated from the upper space by a separating element 4. The pump 5 is provided in the flow connection 13, whereas a stop valve 6 is installed in the parallel flow connection 13a.

The pump 5 and the stop valve 6 are actuated by an appropriate electronic circuit, which acts in response to signals received from a sensor.

The pump 5 conveys damping medium such as oil from the working space 2 to the high-pressure reservoir 3. The pressure in the working space 2, carried by the gas volume in the gas spring space 8, allows an outward force to act on the piston rod 7. The pump 5 and the stop valve 6 prevent the oil from flowing back out from the high-pressure reservoir 3 into the working space 2, where the pressure is much lower. The elastic properties of the piston rod 7 are determined by the gas volume in the gas spring space 8 present at the moment in question. In FIG. 1, the force F1 at the piston rod 7 will be relatively weak; that is, in this diagram, the vehicle is carrying a relatively light load, allowing the gas spring space 8 to expand to a corresponding extent.

In the diagram of FIG. 2, the stop valve 6 is opened, so that oil can flow via the flow connection 13a from the reservoir 3a to the working space 2. The gas space 3b expands correspondingly, whereas the gas volume of the gas spring space 8 is compressed. In this state, the high-pressure reservoir 3 pushes all of the pressure potential available to it into the working space 2 until the pressure has equalized between the working space 2 and the high-pressure reservoir 3. Thus the force F2 pushing the piston rod outward is the maximum possible force, which corresponds to a fully loaded vehicle. When the stop valve 6 is closed again, the piston rod 7 can interact with the now smaller gas volume of the gas spring space 8. Because the volume in the gas spring space 8 is smaller but the pressure is higher, the suspension properties are stiffer and thus better adapted to a vehicle carrying a heavy load. The load-dependent change in the spring characteristic stabilizes the driving behavior of the vehicle, especially when it is fully loaded.

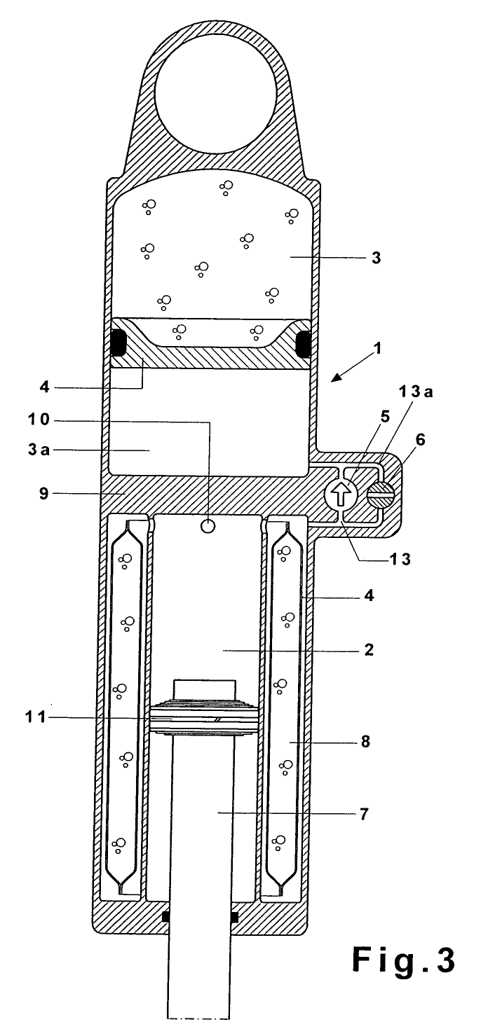

FIG. 3 shows an exemplary embodiment of a piston-cylinder unit 1 with a compact design. The high-pressure reservoir 3 is located above the working space 2 and is separated from it by an intermediate wall 9. The oil-side areas of the working space 2 and of the high-pressure reservoir 3a are connected hydraulically to each other. The pump 5 is installed in the flow connection 13, and the stop valve 6 is installed in the flow connection 13a. The gas volume of the gas spring space 8 interacts with the piston rod 7 by damping medium passing through bores 10. The piston rod 7 carries a damping piston 11, which is equipped with damping valves. The oil and gas in the working space 2 are kept apart by the separating element 4, and in the high-pressure reservoir 3 they are kept apart by the other separating element 4.

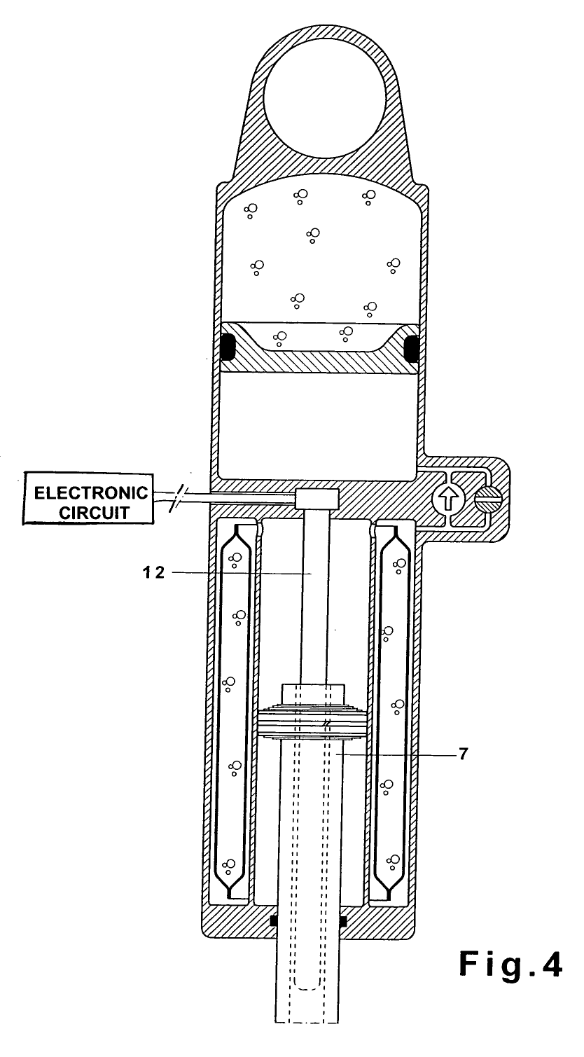

FIG. 4 shows a design according to FIG. 3, where the piston rod 7 is hollow, and where a sensor in the form of a piston travel sensor 12 is received in the bore in the piston rod 7.

In each of the individual exemplary embodiments, the level control function takes place on the basis of the detection of the distance traveled by the piston, whereupon an appropriate electronic circuit actuates the pump 5 and the stop valve 6 as needed.

When the vehicle is standing and becomes loaded beyond a certain point, the sensor 12 transmits a signal which indicates that the body of the vehicle is too low. The stop valve 6 is thus opened. The pressure in the high-pressure reservoir 3 flows into the working space 2, and the gas volume of the gas spring space 8 is thus compressed. The piston rod 7 travels outward until the nominal level of the vehicle body has been reached. Then the stop valve 6 is closed again by means of the electronic circuit.

When the vehicle is standing again and the load is taken away, the piston rod 7 travels farther outward, and the sensor 12 transmits a signal which indicates that the body of the vehicle is too high. The pump 5 is then actuated, and the oil flows from the working space 2 to the high-pressure reservoir 3. Once the vehicle body has been adjusted downward to the appropriate level, the pump is turned off again with the help of the sensor. The gas volume in the gas spring space 8 has expanded to a corresponding extent and has returned to the size it was when the vehicle is empty. The gas volume 3b in the high-pressure reservoir 3, however, has been compressed and is now available again when needed to adjust the vehicle level upward again.

The previously described suspension system for motor vehicles has the direct capacity to adjust the body of the vehicle to one or more different levels through displacement of the oil volume in conjunction with several gas spring spaces.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A suspension system for a motor vehicle, said system comprising:
a working cylinder having a working space filled with damping oil, a piston in said working space, damping valves in said piston, and a piston rod connected to said piston;
a reservoir containing damping oil;
a flow connection connecting the working space to the damping oil reservoir;
a pump in said flow connection for conveying damping oil from the working space to the damping oil reservoir; and
a stop valve in parallel with said pump, said stop valve controlling the return flow or damping oil from the reservoir to the working space.

2. The suspension system of claim 1 further comprising an additional flow connection parallel to the flow connection, said stop valve being located in the additional flow connection.

3. The suspension system of claim 1 further comprising a sensor and an electronic circuit for controlling at least one of said pump and said stop valve.

4. The suspension system of claim 3 wherein the sensor detects a distance traveled by said piston.

5. The suspension system of claim 4 wherein the piston rod has a bore, said sensor being received in said bore.

6. The suspension system of claim 1 wherein the working cylinder and the reservoir are separate components.

7. The suspension system of claim 1 wherein the working cylinder and the reservoir are located in a common component.

8. The suspension system of claim 1 further comprising a separating element in said working cylinder, said separating element separating said working space from a spring space containing a gas.

9. The suspension system of claim 1 further comprising a separating element separating said damping oil reservoir from a spring space containing a gas, said separating element moving to compress said gas in said spring space as pressure in said damping oil reservoir increases.
